(19) United States
(12) Patent Application Publication
(10) Pub. No.: US 2024/0348444 A1
(43) Pub. Date: Oct. 17, 2024

(54) SECURE INTERACTION USING UNI-DIRECTIONAL DATA CORRELATION TOKENS

(71) Applicant: VISA INTERNATIONAL SERVICE ASSOCIATION, San Francisco, CA (US)

(72) Inventor: Adam Ratica, San Francisco, CA (US)

(73) Assignee: VISA INTERNATIONAL SERVICE ASSOCIATION, San Francisco, CA (US)

(21) Appl. No.: 18/290,713

(22) PCT Filed: Jul. 21, 2021
(86) PCT No.: PCT/US2021/042602

§ 371 Date: Jan. 19, 2024

(51) Int. Cl. H04L 9/32; H04L 9/06; H04L 9/40

(52) U.S. Cl. CPC H04L 9/3213; H04L 9/0643; H04L 63/0861

(57) ABSTRACT

A method is disclosed. The method includes receiving by a tokenization server, a request to process an interaction from a user device, where the request includes a user identifier associated with a user. The tokenization server generates a first token using a first one-way cryptographic hash function based on the user identifier, and a second token using a second one-way cryptographic hash function based on the first token. The tokenization server retrieves first information stored in a first data storage associated with the tokenization server based on the second token, and transmits the first token and the first information to a processing computer. The processing computer is programmed to retrieve, from a second data storage associated with the processing computer, second information based on the first token, and execute the interaction based on the first information and the second information.

### CROSS-REFERENCE TO RELATED APPLICATIONS

None.

### BACKGROUND

With the recent proliferation in data, organizations continue to take considerable efforts to store and manage the data. End-user applications, increasing network bandwidths, technological developments in communication devices e.g., mobile devices are some of the factors that contribute to the proliferation of data. As these factors continue to evolve, data security continues to play a key role in the storage and processing of the data by various applications over the networks.

Tokenization is a commonly used mechanism to ensure data integrity and security. Tokenization is the process of replacing sensitive information with a surrogate or token that is not considered to be sensitive and that masks the sensitive information that it replaces. Tokenization techniques can be employed with various types of sensitive information (e.g., payment information such as card information/cardholder data, bank transactions, medical records, criminal records, vehicle driver information, loan applications, stock trading and voter registration, etc.). As such, a first database system involved in processing a user interactions by users stores tokens for the users as opposed to storing user sensitive data of the users. The sensitive information of the users can be stored in a second database system and such information can be linked through the tokens. Although the first database system does not store raw sensitive information, the stored tokens in the first database system are potentially as good as having access to the sensitive information if it can somehow access the second database system. A compromise of the first database system could potentially reveal the tokens to an adversary who could leverage the tokens in a fraudulent manner.

Embodiments of the invention address these and other problems individually and collectively.

### BRIEF SUMMARY

Embodiments provide for secure interaction mechanisms using uni-directional data correlation tokens.

One embodiment includes a method including: receiving by a tokenization server, a request to process an interaction from a user device, the request including a user identifier associated with a user; generating by the tokenization server, a first token using a first one-way cryptographic hash function based on the user identifier; generating by the tokenization server, a second token using a second one-way cryptographic hash function based on the first token; retrieving by the tokenization server, first information stored in a first data storage associated with the tokenization server based on the second token; and transmitting by the tokenization server, the first token and the first information to a processing computer, wherein the processing computer is programmed to retrieve, from a second data storage associated with the processing computer, second information based on the first token, and execute the interaction based on the first information and the second information.

Another embodiment includes a tokenization server comprising: a processor; and a non-transitory computer readable medium coupled to the processor and comprising code, executable by the processor, for implementing a method comprising: receiving a request to process an interaction from a user device, the request including a user identifier associated with a user; generating a first token using a first one-way cryptographic hash function based on the user identifier; generating a second token using a second one-way cryptographic hash function based on the first token; retrieving first information stored in a first data storage associated with the tokenization server based on the second token; and transmitting the first token and the first information to a processing computer, wherein the processing computer is programmed to retrieve, from a second data storage associated with the processing computer, second information based on the first token, and execute the interaction based on the first information and the second information.

Another embodiment includes a method comprising: obtaining by a processing computer, a first token from a tokenization server, the first token being generated based on a user identifier associated with a user; verifying by the processing computer, whether a copy of the first token is stored in a first data storage associated with the processing computer; retrieving by the processing computer, in response to a successful verification, first information associated with the first token, from the first data storage associated with the processing computer; obtaining by the processing computer, second information from a second data storage associated with the tokenization server, wherein the second information is associated with a second token that is generated by the tokenization server based on the first token; and processing an interaction request issued by the user based on the first information and the second information.

Further details regarding embodiments of the invention can be found in the Detailed Description and the Figures.

### BRIEF DESCRIPTION OF THE DRAWINGS

FIG. 1 shows a block diagram of an interaction system according to an embodiment.

FIG. 2A depicts a flowchart illustrating an initialization process performed by the interaction system according to another embodiment.

FIG. 2B shows a flowchart illustrating an execution/usage process performed by the interaction system according to another embodiment.

FIG. 3 shows a block diagram of a mobile communication device according to an embodiment.

FIG. 4 shows a block diagram of a tokenization server according to an embodiment.

FIG. 5 shows a block diagram of a processing computer according to an embodiment.

### DETAILED DESCRIPTION

Prior to discussing embodiments of the invention, some terms can be described in further detail.

A “local data connection” can include a short range communication connection between two or more devices that are intended to interact with each other. A local data connection can be formed using an RF mode of communication such as near field communications (NF), Bluetooth, Bluetooth Low Energy (BLE), etc. In other embodiments, another mode of communication such as light (e.g., infrared) or audio signals may be used.

A “mobile device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, wearable devices (e.g., watches), vehicles (e.g., cars), etc. A mobile device may comprise any suitable hardware and software for performing such functions, and may also include multiple devices or components (e.g., when a device has remote access to a network by tethering to another device—i.e., using the other device as a relay-both devices taken together may be considered a single mobile device).

“Authentication data” may include any data suitable for authenticating a user or mobile device. Authentication data may be obtained from a user or a device that is operated by the user. Examples of authentication data obtained from a user may include PINs (personal identification numbers), passwords, etc. Examples of authentication data that may be obtained from a device may be include device serial numbers, hardware secure element identifiers, device fingerprints, phone numbers, IMEI numbers, etc.

An “access device” may be any suitable device for obtaining access to a resource. An access device may generally be located in any suitable location, such as at the location of a merchant. An access device may be in any suitable form. Some examples of access devices include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a payment device and/or a user mobile device.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

A “credential” may be any suitable information that serves as reliable evidence of worth, ownership, identity, or authority. A credential may be a string of numbers, letters, or any other suitable characters that may be present or contained in any object or document that can serve as confirmation.

A “token” may be a substitute value for a credential. A token may be a string of numbers, letters, or any other suitable characters. Tokens may be generated as hash values by inputting the credential to a cryptographic hash function. Examples of tokens include access tokens such as payment tokens, data that can be used to access secure systems or locations, etc.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

A “server computer” is typically a powerful computer or cluster of computers. For example, the server computer can be a large mainframe, a minicomputer cluster, or a group of servers functioning as a unit. In one example, the server computer may be a database server coupled to a Web server.

A “tokenization server” can include a system that generates tokens. Specifically, the tokenization server can receive user data as input and utilize a hash function to generate a hash (i.e., a token) corresponding to the user data. In some embodiments, a tokenization server can facilitate requesting, determining (e.g., generating) and/or issuing tokens, as well as maintaining an established mapping of tokens to primary account numbers (PANs) in a repository. In some embodiments, the tokenization server may establish a token assurance level for a given token to indicate the confidence level of the token to PAN binding.

An “authorizing entity” or a “processing computer” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “user” may include an individual. In some embodiments, a user may be associated with one or more personal accounts and/or user devices.

An “interaction” can include any reciprocal action or influence. Examples of interactions can include transactions such as data processing transactions, payment transactions, authentication transactions, etc.

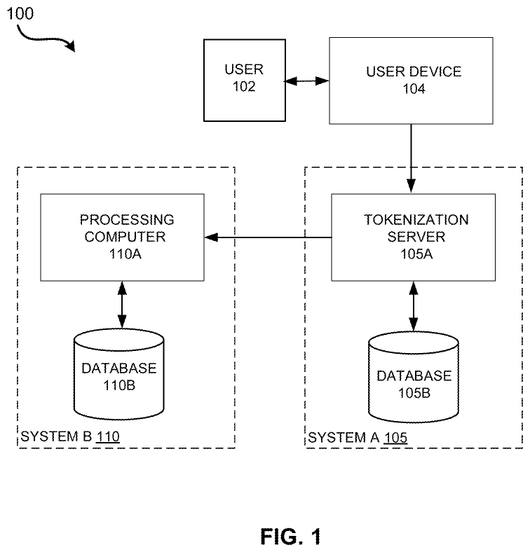

FIG. 1 shows a block diagram of an interaction system 100 according to an embodiment. The interaction system 100 includes a user device 104 operated by a user 102, a first system (referred to herein as system A) 105 and a second system (referred to herein as system B) 110. The first system A 105 includes two sub-systems i.e., sub-system A1 comprising a tokenization server 105A, and sub-system A2 comprising a data storage i.e. a database 105B associated with sub-system A1. The second system 110 includes a processing computer 110A and a database 110B that is associated with the processing computer 110A.

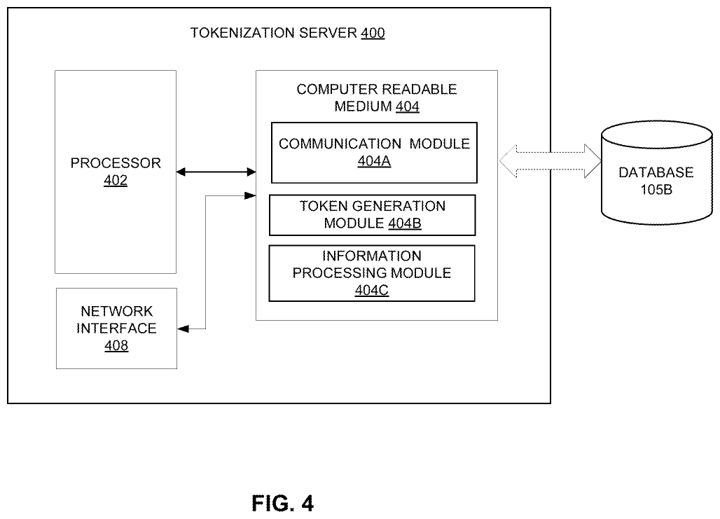

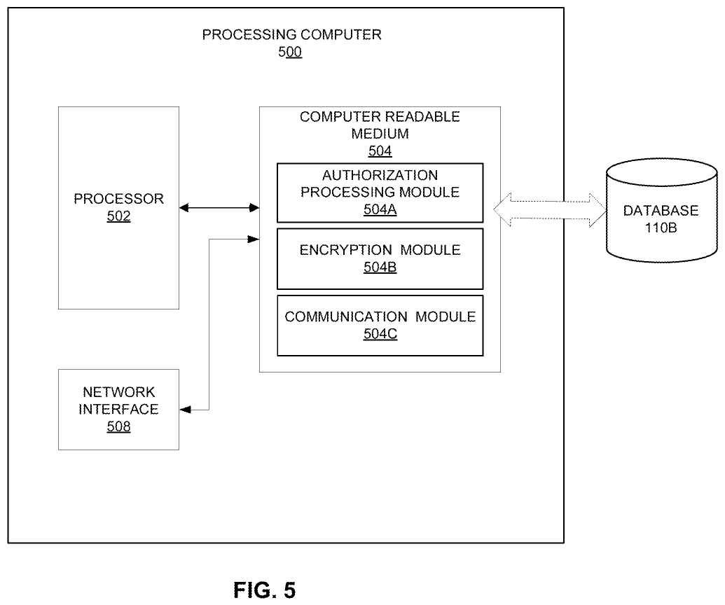

According to some embodiments, the sub-system A1 is a stateless subsystem and is programmed to perform tokenization operations based on information received from the user device 104. The sub-system A2 i.e., the database 105B is a stateful subsystem and is programmed to store a token generated by sub-system A1. Details regarding the sub-system A1 i.e., the tokenization server 105A, and the processing computer 110A included in system B 110 are described later in detail with reference to FIG. 4 and FIG. 5, respectively.

Embodiments of the present disclosure are directed to mechanisms of conducting secure interactions using uni-directional data correlation tokens. Specifically, different portions of data related to a user are associated with different tokens (generated by the tokenization server 105A) and stored in distinct databases. System A 105 and system B 110 as shown in FIG. 1 collaborate with one another to process interaction requests that are issued by the user 102 in a secure manner.

According to some embodiments, interaction system 100 operates in one of two modes: an initialization mode and an execution/usage mode. The initialization mode corresponds to setting up an account of the user with respect to system A 105 and system B 110, whereas in the execution/usage mode the user utilizes the interaction system 100 to conduct an interaction. In the initialization mode of operation, the user 102 utilizes the user device 104 to initiate a setup request that is transmitted to the tokenization server 105A. The request to set up an user account (also referred to herein as an initialization request) is transmitted from the user device 104 to the tokenization server 105A. By one embodiment, the setup request includes an user identifier (e.g., email ID, telephone number, etc.) associated with the user, and one or more pieces of information. For sake of simplicity and illustration, we assume that the set up request includes a first information and a second information. It is appreciated that the specific data content included in the first information and the second information depends on a type of interaction request initiated by the user. Details pertaining to the types of interaction requests and the associated first and second information are described below.

The first information and the second information together, can be used to facilitate an interaction such as a transaction. For example, the first information could be details regarding medical information such as blood work data, while the second information could be a medical records number. In another example, the first information could be details regarding a payment transaction (e.g., items purchased, total price, etc.), while the second information could be a primary account number (PAN) associated with a credit or debit card account. In yet another example, the first information could be one set of information about a user such as a birthday and the second information could be another set of information about a user such as a social security number.

Upon the tokenization server 105A receiving the initialization request, the tokenization server 105A generates a first token using a one-way cryptographic hash function based on the user identifier. The generated first token is associated with a piece of information e.g., second information. The generated first token and the second information is transmitted by the tokenization server 105A to the processing computer 110A. The processing computer 110A stores the received second information associated with the first token in a data storage (e.g., database 110B) that is associated with the processing computer 110A.

Thereafter, the tokenization server 105A generates a second token using another one-way cryptographic hash function based on the first token. The tokenization server 105A associates the generated second token with the first information. The tokenization server 105A stores the first information associated with the second token in the database 105B that is associated with the tokenization server 105A. It is appreciated that the first one-way cryptographic hash function is different than the second one-way cryptographic hash function. Each of the first one-way cryptographic hash function and the second one-way cryptographic hash function may be one of a secure hash algorithm (SHA-2) function, a SHA-3 function, or a hash message authentication code (HMAC) cryptographic function that is associated with a secret cryptographic key.

Thus, as described above, in the initialization mode of operation, the user securely stores a portion of the information associated with the user (e.g., first information) in a database associated with the tokenization server e.g., database 105B, and another portion of information associated with the user (e.g., second information) in another separate database (e.g. database 110B) associated with the processing computer 110A. In doing so, the user can issue a request to process an interaction (in an execution/usage mode of operation), which is executed based on the first information and second information that are stored in their respective databases.

According to one embodiment, in the execution/usage mode of operation of the interaction system depicted in FIG. 1, the user 102 utilizes the user device 104 to initiate a request to process an interaction. The request to process the interaction is transmitted to the tokenization server 105A. The request to process the interaction includes an user identifier (e.g., email ID, telephone number of the user, etc.) associated with the user. Upon receiving the request to process the interaction, the tokenization server 105A generates the first token using the one-way cryptographic hash function based on the user identifier. Subsequently, the tokenization server 105A generates a second token using another one-way cryptographic hash function based on the first token.

The tokenization server 105A utilizes the second token to retrieve, from the data storage associated with the tokenization sever i.e., database 105B, user information (e.g., first information) that was previously stored in the database 105B during the initialization mode of operation. Specifically, the tokenization server verifies whether a copy of the second token was previously stored in database 105B (associated with the tokenization server 105A). In response to a successful verification i.e., finding a match of the second token, the tokenization server retrieves the first information that is associated with the second token from the database 105B.

The tokenization server 105A then transmits the retrieved first information along with the generated first token to the processing computer 110A. The processing computer 110A utilizes the first token (received from the tokenization server 105A) to retrieve, from a data storage associated with the processing computer 110A i.e., database 110B, user information (e.g., second information) that was previously stored in the database 110B during the initialization mode of operation. Specifically, the processing computer 110A verifies whether a copy of the first token was previously stored in database 110B.

Upon a successful verification i.e., finding a match of the first token, the processing computer 110A retrieves the second information from the database 110B. In this manner, the processing computer 110A retrieves a portion of the user information (e.g., second information) from a database associated with the processing computer 110A, and obtains another portion of the user information (e.g., first information) that is stored in a separate database (i.e., database 105B) from the tokenization server 105A. Upon obtaining the first information and the second information, the interaction system 100 executes the interaction request based on the first and second information.

It is appreciated that the geographical location of system A 105 and system B 110 of the interaction system 100 may be different i.e., the database 105B associated with the tokenization server 105 may be located in a geographical location that is different than the location of database 110B associated with the processing computer 110A. In FIG. 1, the user device 104, the tokenization server 105A, and the processing computer 110A may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

According to one embodiment, an interaction processed by the interaction system 100 may be a payment transaction interaction with respect to a purchase of a commodity by the user 102. In this case, the first information (stored in the database 105B, that is associated with the tokenization server 105A) may correspond to non-payment information. Examples of non-payment information may include a list of items that are purchased, and/or a transaction amount, etc. The second information that is stored in the database 110B (associated with the processing computer 110A) may correspond to payment information. By some embodiments, the payment information may include sensitive information such as a type of card (i.e., credit card or debit card) that is intended to be used by the user to complete the transaction, a CVV code, a primary account number (PAN) of the user, a virtual card number, etc. By some embodiments, the non-payment information may include information including an identifier of the resource provider, an identifier of the commodity/product being purchased by the user, a list of resource providers that offer the commodity, a transaction amount, etc. In the payment transaction interaction, user sensitive/confidential information e.g., payment information is stored in the database associated with the processing computer, whereas other information related to the transaction i.e., non-payment information is stored in the database associated with the tokenization server. Each of the payment information and non-payment information is associated with a unique token.

Referring to FIG. 1, in the payment transaction interaction, sub-system A1 is a stateless subsystem and may correspond to an intermediate server or processor configured for performing secure tokenization based on information received from the user device. The sub-system A2 is a stateful subsystem and may correspond to a data storage device or memory configured to store a token generated by sub-system A1. The second system i.e., system B may correspond to a payment terminal or a payment server configured for authenticating payment transactions based on the first and second information. System B may comprise a payment processor and a data storage device or memory. According to one embodiment, in the case of a payment transaction interaction, the tokenization server 105A may retrieve a list of merchants that offer a product associated with a transaction from the database 105B, and determine, for each merchant in the list of merchants, a cost of the product associated with the merchant. The tokenization server 105A may select one merchant from the list of merchants e.g., based on the merchant offering the product at the lowest cost, and send to the payment processing computer, a merchant identifier associated with the one merchant and the cost of the product associated with the one merchant. The processing computer 110A may process the payment transaction request and send a notification to the user 102 in response to successful completion of the transaction request.

According to one embodiment, an interaction processed by the interaction system 100 may correspond to a secure data retrieval and processing interaction. For instance, consider a medical application where patient information (e.g., medical records) are stored securely in remote databases to prevent fraudulent activities. In this case, the first information (i.e., information stored in the database 105B associated with the tokenization server 105A) may include information such as an email ID of the user, demographic information of the user including an age of the user, a gender of the user, and/or a nationality of the user. The second information that is stored in the database 110B associated with the processing computer 110A may include more sensitive (and confidential) information such as biometric information of the user. The biometric information may include at least a fingerprint scan, an iris scan, a retina scan, a voice sample, or a facial scan of the user. Further, the second information may comprise patient treatment data, patient CT/MRI scans, etc. In this case, the user 102 (e.g., a patient) may utilize the interaction system 100 to initiate a data retrieval/processing request, wherein the processing computer obtains information (e.g., first and second information) related to the patient from different databases for further processing. For instance, the processing computer may be programmed to transmit the obtained first and second information to another information processing server (e.g., a medical facility) that is programmed to analyze patient scans and generate a report based that is transmitted to the user. In this manner, the user may share confidential and sensitive medical information between different medical facilities in a secure manner.

According to another embodiment, the interaction processed by system 100 may correspond to a data storage and migration type interaction conducted in a cloud environment. In a cloud environment customers (i.e., users) typically execute various applications/data on several virtual machines hosted in different customer tenancies. Such customer tenancies may span different geographical regions. In such a case, a customer may desire to migrate applications/data from a source cloud environment to a target cloud environment. The interaction system 100 may enable such migration interactions, wherein first information stored in the database 105B associated with the tokenization server 105A may include information such as login information of the user e.g., email ID, and second information may correspond to biometric information of the user as well as the sensitive information pertaining to the applications of the customer that are to be migrated. In this case, the processing computer that may hosted for instance in a source cloud environment, may be programmed to retrieve the information that is to be migrated (upon successful customer authentication) and transmit the retrieves applications to the target cloud environment. In what follows, there is described in detail the initialization mode of operation and the execution/usage mode of operation of the interaction system 100.

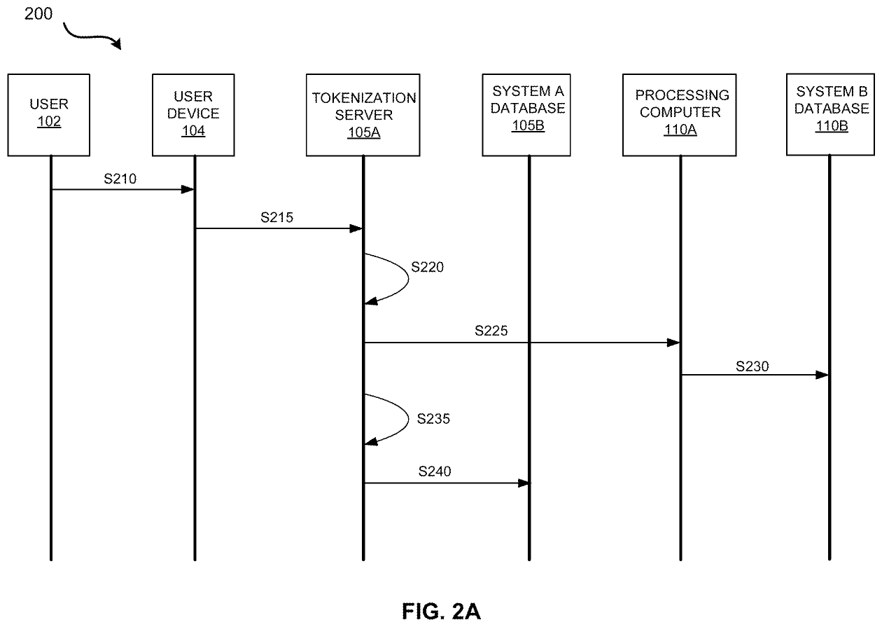

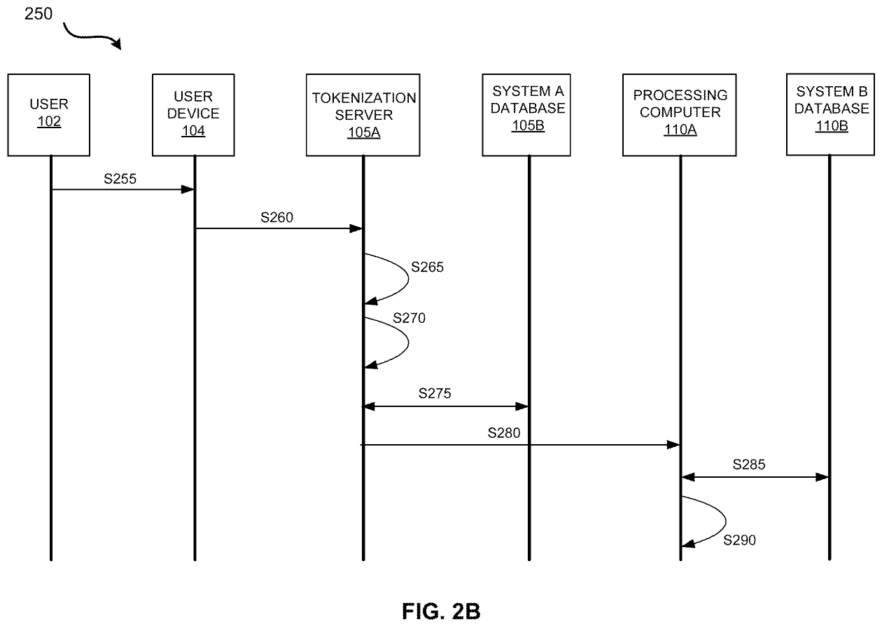

FIG. 2A depicts a flowchart 200 illustrating a method for setting up an account of the user (i.e., an initialization process) with respect to the tokenization server and the processing computer. FIG. 2B depicts a flowchart 250 illustrating a method for processing an interaction request initiated by the user. The methods shown in FIG. 2A and FIG. 2B can also be described with reference to the system diagram of FIG. 1. It is appreciated that a user setup is performed in order to enable the user to later initiate interaction requests. Moreover, the methods described below can relate to any type of interaction requests e.g., a payment transaction, a secure data retrieval interaction performed in a cloud environment, a medical records processing interaction, etc. However, embodiments of the invention can be applied to other types of interaction requests, which require secure data storage mechanisms.

At step S210, the user 102 utilizes the user device 104 to initiate a setup request that is transmitted to the tokenization server 105A. At step S215, a setup request to set up a user account (also referred to herein as an initialization request) is transmitted from the user device 104 to the tokenization server 105A. By one embodiment, the setup request includes a user identifier (e.g., email ID) associated with the user and one or more pieces of information. For instance, the set up request may include a first information and a second information. As described herein with reference to FIG. 1, the first information and second information may include user related data based on a type of interaction request the user is interested in.

At step S220, the tokenization server 105A generates a first token using a one-way cryptographic hash function based on the user identifier. The generated first token along with the second information (received in step S215) is transmitted by the tokenization server 105A to the processing computer 110A in step S225. In step S230, the processing computer 110A stores the received second information associated with the first token in a data storage (e.g., database 110B) that is associated with the processing computer 110A.

The process the moves to step S235, where the tokenization server 105A generates a second token using another one-way cryptographic hash function based on the first token. Thereafter, the tokenization server 105A associates the generated second token with the first information (received in step S215). It is appreciated that the first one-way cryptographic hash function is different from the second one-way cryptographic hash function. Each of the first one-way cryptographic hash function and the second one-way cryptographic hash function may be one of a hash message authentication code (HMAC) cryptographic function that is associated with a cryptographic key (e.g. a secret key) or a non-HMAC cryptographic function. For instance, non-HMAC cryptographic functions may include cryptographic functions such as a secure hash algorithm (SHA-2) function, a SHA-3 function, or the like. Upon completion of step S240, the setup process is complete, whereby the user has securely stored a portion of the information associated with the user (e.g., first information) in a database associated with the tokenization server e.g., database 105B, and another portion of information associated with the user (e.g., second information) in another separate database (e.g. database 110B) associated with the processing computer 110A. In doing so, the user can issue a request to process an interaction, which is executed based on the first information and second information stored in their respective databases. Details pertaining to processing the interaction request are described next with reference to FIG. 2B.

FIG. 2B depicts a flowchart 250 illustrating a method for processing an interaction request initiated by the user. The process commences in step S255, where the user 102 utilizes the user device 104 to initiate a request to process an interaction. The request to process the interaction is transmitted to the tokenization server 105A at step S260. By one embodiment, the request to process the interaction includes an user identifier (e.g., email ID, telephone number of the user, etc.) associated with the user. In some embodiments, the user may wish to conduct a transaction with a resource provider such as a merchant and may push a payment to that resource provider.

The process then moves to step S265 where the tokenization server 105A generates a first token using a one-way cryptographic hash function based on the user identifier. Thereafter, in step S270, the tokenization server 105A generates a second token using another one-way cryptographic hash function based on the first token. The first one-way cryptographic hash function is different than the second one-way cryptographic hash function. Each of the first one-way cryptographic hash function and the second one-way cryptographic hash function may be one of a hash message authentication code (HMAC) cryptographic function that is associated with a cryptographic key or a non-HMAC cryptographic function. For instance, non-HMAC cryptographic functions may include cryptographic functions such as a secure hash algorithm (SHA-2) function, a SHA-3 function, or the like.

The process then moves to step S275, where the tokenization server 105A utilizes the second token to retrieve, from the data storage associated with the tokenization sever i.e., database 105B, user information (e.g., first information) that was previously stored in the database 105B during the user setup process. Specifically, the tokenization server verifies whether a copy of the second token was previously stored in database 105B that is associated with the tokenization server 105A. In response to a successful verification i.e., finding a match of the second token, the tokenization server retrieves the first information (previously stored) and associated with the second token from the database 105B.

In step S280, the tokenization server 105A transmits the retrieved first information along with the generated first token to the processing computer 110A. In step S285, the processing computer 110A utilizes the first token (received from the tokenization server 105A) to retrieve, from a data storage associated with the processing computer 110A i.e., database 110B, user information (e.g., second information) that was previously stored in the database 110B during the user setup process. Specifically, the processing computer 110A verifies whether a copy of the first token was previously stored in database 110B that is associated with the processing computer 110A.

In response to a successful verification i.e., finding a match of the first token, the processing computer 110A retrieves the second information (previously stored) and associated with the first token from the database 110B. In this manner, the processing computer 110A retrieves a portion of the user information (e.g., second information) from a database associated with the processing computer, and obtains another portion of the user information (e.g., first information) that is stored in a separate database (i.e., database 105B) from the tokenization server. Upon obtaining the first information and the second information, the process in step 290 proceeds to execute the interaction request. It is appreciated that the specific steps involved in the processing of the interaction vary based on the type of interaction request. For example, in the case where the interaction request corresponds to a payment transaction, the processing computer proceeds to execute a payment transaction initiated by the user based on the obtained first and second information. If the first information comprises a transaction amount, and a merchant identifier, and the second information comprises a payment account number, then the processing computer can generate an authorization request message comprising the first and second information. The authorization request message can be sent to an authorizing entity computer (e.g., an issuer computer) for authorization. The authorizing entity computer can reply with an authorization response message and send it back to the processing computer and possibly the resource provider (e.g., a merchant) that initiated the interaction with the user 102.

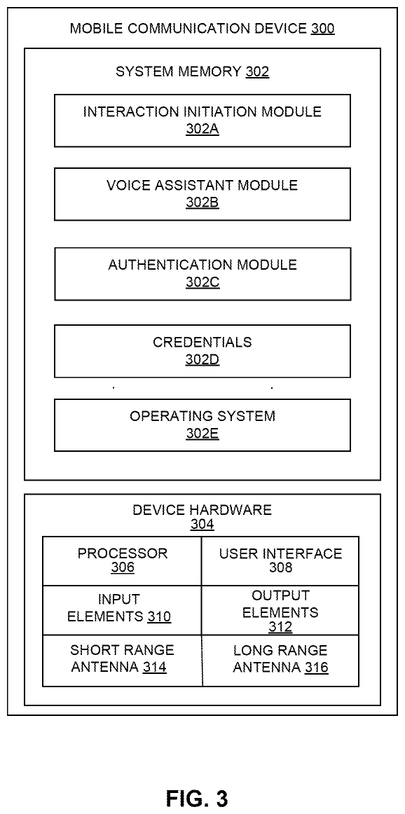

FIG. 3 illustrates a mobile communication device 300 according to an embodiment. The mobile communication device 300 corresponds to the user device 104 of FIG. 1 that is utilized by the user 102 to initiate a request to process an interaction. The mobile communication device 300 may include device hardware 304 coupled to a system memory 302.

Device hardware 304 may include a processor 306, a short range antenna 314, a long range antenna 316, input elements 310, a user interface 308, and output elements 312 (which may be part of the user interface 308). Examples of input elements may include microphones, keypads, touchscreens, sensors, etc. Examples of output elements may include speakers, display screens, and tactile devices. The processor 306 can be implemented as one or more integrated circuits (e.g., one or more single core or multicore microprocessors and/or microcontrollers), and is used to control the operation of mobile communication device 300. The processor 306 can execute a variety of programs in response to program code or computer-readable code stored in the system memory 302, and can maintain multiple concurrently executing programs or processes.

The long range antenna 316 may include one or more RF transceivers and/or connectors that can be used by mobile communication device 300 to communicate with other devices and/or to connect with external networks. The user interface 308 can include any combination of input and output elements to allow a user to interact with and invoke the functionalities of mobile communication device 300. The short range antenna 314 may be configured to communicate with external entities through a short range communication medium (e.g. using Bluetooth, Wi-Fi, infrared, NFC, etc.). The long range antenna 316 may be configured to communicate with a remote base station and a remote cellular or data network, over the air.

The system memory 302 can be implemented using any combination of any number of non-volatile memories (e.g., flash memory) and volatile memories (e.g. DRAM, SRAM), or any other non-transitory storage medium, or a combination thereof media. The system memory 302 may store computer code, executable by the processor 306, for performing any of the functions described herein.

The system memory 302 may also store an interaction initiation module 302A, a voice assistant module 302B, an authentication module 302C, credentials 302D, and an operating system 302E, The interaction initiation module 302A may include instructions or code initiating and conducting an interaction with an external device such as a tokenization server or a processing computer. It may include code, executable by the processor 306, for generating and transmitting interaction initiation request messages, as well as receiving and forwarding authorization response messages. The interaction initiation request messages may include a user identifier associated with user in order to commence the interaction request. It may also include code, executable by the processor 306, for forming a local connection or otherwise interacting with an external access device. The voice assistant module 302B may comprise code, executable by the processor 306, to receive voice segments, and generate and analyze data corresponding to the voice segments. The authentication module 302C may comprise code, executable by the processor 306, to authenticate a user. This can be performed using user secrets (e.g., passwords) or user biometrics.

System memory 302 may also store credentials 302D. Credentials may also include information identifying the mobile communication device 300 and/or the user of the mobile communication device 300. Examples of credentials may include a public key associated with the mobile communication device 300 and/or a user of the mobile communication device 300, a digital signature (e.g., the public key of the mobile communication device 300 signed by a key of the authentication system), payment credentials, biometric data (e.g., biometric samples or templates), user identifiers (e.g., e-mail addresses, phone numbers, etc.

FIG. 4 depicts a tokenization server 400. By some embodiments, the tokenization server 400 of FIG. 4 corresponds to the tokenization server 105A included in system A 105 of the interaction processing system depicted in FIG. 1. The tokenization server 400 includes a processor 402, a computer readable medium 404, and a network interface 408.

The computer readable medium 404 may comprise a communications module 404A, a token generation module 404B, and an information processing module 404C. The communication module 404A may comprise code that causes the processor 402 to generate messages, forward messages, reformat messages, and/or otherwise communicate with other entities. Specifically, the communication module 404A may include a variety of communications means e.g., short range antennas, long range antennas, etc., to communicate with other devices e.g., mobile communication device of FIG. 3.

In some embodiments, the computer readable medium may comprise code executable by the processor 402 to implement operations including receiving by a tokenization server, a request to process an interaction from a user device, the request including a user identifier associated with a user; generating by the tokenization server, a first token using a first one-way cryptographic hash function based on the user identifier; generating by the tokenization server, a second token using a second one-way cryptographic hash function based on the first token; retrieving by the tokenization server, first information stored in a first data storage associated with the tokenization server based on the second token; and retransmitting by the tokenization server, the first token and the first information to a processing computer, wherein the processing computer is programmed to retrieve, from a second data storage associated with the processing computer, second information based on the first token, and execute the interaction based on the first information and the second information

By some embodiments, the communications module 404A may include one or more RF transceivers and/or connectors that can be used by tokenization server 400 to communicate with other devices and/or to connect with external networks. The short range antennas of the communications module 404A may be configured to communicate with external entities through a short range communication medium (e.g. using Bluetooth, Wi-Fi, infrared, NFC, etc.). The long range antennas of the communication module 404A may be configured to communicate with a remote base station and a remote cellular or data network, over the air. An instance of a communication channel formed by the tokenization server 400, may be a communication channel formed with the user device e.g., the mobile communication device 300. In such a communication channel, the mobile device may be programmed to transmit to the tokenization server 400, a user identifier associated with a user of the mobile device. As described herein, the user identifier may be included in a request (issued by the mobile communication device 300) to process an interaction.

The token generation module 404B may comprise code that causes the processor 402 to generate tokens. For example, the token generation module 404B may contain logic that causes the processor 402 to generate different tokens, each of which are to be associated with specific information received from the mobile communication device 300. For instance, as described previously with reference to FIG. 1, the tokenization server may be programmed to generate a first token based on a user identifier received from the mobile communication device 300. The tokenization server 400 may be further programmed to generate a second token based on the previously generated first token. By some embodiments, the token generation module 404B may programmed to generate each of the first token and the second token by implementing a one-way cryptographic hash function. The token generation module 404B may utilize unique one-way cryptographic hash functions (e.g., a secure hash algorithm (SHA-2) function, or a SHA-3 function i.e., non-HMAC cryptographic functions, and/or a hash message authentication code (HMAC) cryptographic function) to generate the first token and the second token, respectively.

The information processing module 404C may be programmed to receive different types of information (e.g., first information and second information as described herein with respect to FIG. 1) from the user device e.g., mobile communication device 300, and associate a unique token generated by the token generation module 404B with each piece of information. For instance, the information processing module 404C may associate a first token with second information and transmit the second information (associated with the first token) to a processing computer. The information processing module 404C may associate a second token with first information and store the first information (associated with the second token) in a data storage 105B that is associated with the tokenization server 400.

According to some embodiments, with respect to processing an interaction request pertaining to a payment transaction, the information processing module 404C may be programmed to retrieve first information (e.g., information including a list of resource providers that offer a product associated with the transaction) and determine, for each resource provider in the list of resource providers, a cost of the product offered by a specific resource provider. The information processing module 404C may be further programmed to identify a resource provider offering the product at a lowest cost and transmit the identified information to a processing computer.

FIG. 5 shows a block diagram of a processing computer 500 according to an embodiment. The processing computer 500 may correspond to the processing computer 110A included in system B 110 of the interaction processing system of FIG. 1. The processing computer 500 may comprise a processor 502, which may be coupled to a computer readable medium 504, and a network interface 508. The processing computer 500 is also communicatively coupled with a data storage 110B. The data storage 110B may contain mapping information between tokens and information associated with users, and/or communication device identifiers such as phone numbers, IP addresses, device identifiers, etc.

The computer readable medium 504 may comprise a number of software modules including an authorization processing module 504A, an encryption module 504B, and a communication module 504C. The computer readable medium may also comprise a clearing and settlement module (not shown).

The computer readable medium 504 may comprise code, executable by the processor 502 to perform operations including: obtaining by a processing computer, a first token from a tokenization server, the first token being generated based on a user identifier associated with a user; verifying by the processing computer, whether a copy of the first token is stored in a first data storage associated with the processing computer; retrieving by the processing computer, in response to a successful verification, first information associated with the first token, from the first data storage associated with the processing computer; obtaining by the processing computer, second information from a second data storage associated with the tokenization server, wherein the second information is associated with a second token that is generated by the tokenization server based on the first token; and processing an interaction request issued by the user based on the first information and the second information.

The authorization processing module 504A may comprise code that can cause the processor 602 to evaluate authorization request messages for interactions and determine if the interactions should be authorized. The authorization processing module 504A may also include code for routing or modifying authorization request and response messages as they pass between various parties such as authorizing entity computers (e.g., issuer computers) and transport computers (e.g., acquirer computers).

The encryption/decryption module 504B may include any suitable encryption/decryption algorithms to encrypt data in embodiments of the invention. Suitable data encryption/decryption algorithms may include DES, triple DES, AES, etc. It may also store encryption keys that can be used with such encryption/decryption algorithms. The encryption module 504B may utilize symmetric or asymmetric encryption techniques to encrypt and/or verify data. Cryptographic keys that may be used by the encryption/decryption module 504B may be securely stored in the data storage 110B.

The communication module 504C may comprise code that causes the processor 502 to generate messages, forward messages, reformat messages, and/or otherwise communicate with other entities.

Embodiments of the invention have a number of advantages. Embodiments of the invention can allow users to obtain information stored in separate databases in a secure manner and execute interaction requests with respect to the obtained information. Further, embodiments of the invention protect sensitive information by associating the information with a token that is generated by a one-way irreversible hash functions. Security associated with transactions is attained by: (i) splitting system A into a stateless sub-system (i.e., sub-system A1) and a stateful sub-system (i.e., sub-system A2), (ii) configuring the stateless sub-system (with which the user device and the second system B interact) not to store any information (hence there is no data to crack or attempt to retrieve, and thus more immune to fraudulent attack), and (iii) generating the first token and the second token by two different one-way cryptographic hash functions, wherein the first token, that is required for performing the transaction at second system B, is different from the second token that is stored in sub-system A2. Accordingly, even if the second token is stolen from the first system A, the interaction cannot be performed using only the second token at the second system B, thus ensuring the security. Furthermore, due to irreversibility and use of different one-way cryptographic hash functions, the first token can never be retrieved nor computed from the second token, in case of theft of the second token from the first system A.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving by a tokenization server, a request to process an interaction from a user device, the request including a user identifier associated with a user;
generating by the tokenization server, a first token using a first one-way cryptographic hash function based on the user identifier;
generating by the tokenization server, a second token using a second one-way cryptographic hash function based on the first token;
retrieving by the tokenization server, first information stored in a first data storage associated with the tokenization server based on the second token; and
transmitting by the tokenization server, the first token and the first information to a processing computer, wherein the processing computer is programmed to retrieve, from a second data storage associated with the processing computer, second information based on the first token, and execute the interaction based on the first information and the second information.

2. The method of claim 1, wherein the first one-way cryptographic hash function is different than the second one-way cryptographic hash function.

3. The method of claim 1, wherein the first information stored in the first data storage associated with the tokenization server is different than the second information stored in the second data storage associated with the processing computer.

4. The method of claim 1, wherein the first information includes at least an email ID of the user or demographic information of the user including an age of the user, a gender of the user, and/or a nationality of the user.

5. The method of claim 1, wherein the second information includes at least biometric information of the user.

6. The method of claim 5, wherein the biometric information includes at least a fingerprint scan, an iris scan, a retina scan, a voice sample, or a facial scan of the user.

7. The method of claim 1, wherein the second information is not stored by the tokenization server.

8. The method of claim 1, wherein the first data storage associated with the tokenization server is not directly coupled to the processing computer.

9. The method of claim 1, wherein the first one-way cryptographic hash function and the second one-way cryptographic hash function is one of a secure hash algorithm (SHA-2) function, or a SHA-3 function.

10. The method of claim 1, wherein at least one of the first one-way cryptographic hash function and the second one-way cryptographic hash function is a hash message authentication code (HMAC) cryptographic function.

11. The method of claim 10, wherein the HMAC cryptographic function is associated with a secret cryptographic key.

12. The method of claim 1, wherein the tokenization server does not transmit the second token to the processing computer.

13. The method of claim 1, wherein prior to receiving the request to process the interaction, the tokenization server receives, from the user device, an initialization request to setup an account of the user with respect to the tokenization server and the processing computer.

14. The method of claim 13, further comprising:
receiving by the tokenization server, the user identifier associated with the user, the first information and the second information;
sending by the tokenization server, the first token and the second information to the processing computer, the first token being associated with the second information and being stored in the second data storage associated with the processing computer; and
storing by the tokenization server, the second token and the first information in the first data storage associated with the tokenization server, the second token being associated with the first information.

15. A tokenization server comprising:
a processor; and
a non-transitory computer readable medium coupled to the processor and comprising code, executable by the processor, for implementing a method comprising
receiving a request to process an interaction from a user device, the request including a user identifier associated with a user;
generating a first token using a first one-way cryptographic hash function based on the user identifier;
generating a second token using a second one-way cryptographic hash function based on the first token;
retrieving first information stored in a first data storage associated with the tokenization server based on the second token; and
transmitting the first token and the first information to a processing computer, wherein the processing computer is programmed to retrieve, from a second data storage associated with the processing computer, second information based on the first token, and execute the interaction based on the first information and the second information.

16. The tokenization server of claim 15, wherein each of the first one-way cryptographic hash function and the second one-way cryptographic hash function is a hash message authentication code (HMAC) cryptographic function, and wherein the first one-way cryptographic hash function is different than the second one-way cryptographic hash function.

17. The tokenization server of claim 15, the first one-way cryptographic hash function is a hash message authentication code (HMAC) cryptographic function, and the second one-way cryptographic hash function is non-HMAC cryptographic function.

18. The tokenization server of claim 15, wherein a first location of the first data storage associated with the tokenization server is different than a second location of the second data storage associated with the processing computer.

19. A method comprising:
obtaining by a processing computer, a first token from a tokenization server, the first token being generated based on a user identifier associated with a user;
verifying by the processing computer, whether a copy of the first token is stored in a first data storage associated with the processing computer;
retrieving by the processing computer, in response to a successful verification, first information associated with the first token, from the first data storage associated with the processing computer;
obtaining by the processing computer, second information from a second data storage associated with the tokenization server, wherein the second information is associated with a second token that is generated by the tokenization server based on the first token; and
processing an interaction request issued by the user based on the first information and the second information.

20. The method of claim 19, wherein the processing of the interaction request further comprises:
transmitting by the processing computer, the first information and the second information to an information processing server that is programmed to generate a report based on the first information and the second information, the report being transmitted to the user.
